(19) United States
(12) Patent Application Publication
(10) Pub. No.: US 2001/0027530 A1
(43) Pub. Date: Oct. 4, 2001

(54) Wake-up system and method for universal serial bus of wireless input device

(76) Inventors: Andy Yen, Taichung (TW); Albert Yang, Kaohsiung (TW); Ray Chiu, Pan Chia City (TW)

Correspondence Address: STEVENS, DAVIS, MILLER & MOSHER, L.L.P., Suite 850, 1615 L STREET, N.W., WASHINGTON, DC, 20036, US

(21) Appl. No.: 09/779,452

(22) Filed: Feb. 9, 2001

(30) Foreign Application Priority Data
Feb. 11, 2000 (TW) 089102570

(51) Int. Cl. G06F 1/26; G06F 1/28; G06F 1/30

(52) U.S. Cl. 713/300

(57) ABSTRACT

A wake-up system for universal serial bus of computer wireless input device comprises a USB 10 connected to computer main body 1, and a receiver 8 connected to the USB 10, wherein a wireless keyboard 2 and a wireless mouse 3 transmit infrared or RF signals to be received by the receiver 8 to control and operate the program executed by the computer main body 1. When the power management device of the computer system switches the computer and the USB 10 into suspension mode, the receiver 8 is set to switch between a suspension mode and an operating mode, and the average current (Iₐᵥₑ) of the receiver 8 must be less than the limit average current (SUBIₐᵥₑ) of USB 10 during suspension mode. When the computer is at suspension status and the user wants to use the computer again, the user can operate the wireless keyboard 2 or mouse 3 to transmit a continuous wake-up signal which can be received and detected by the receiver 8 during its operating mode to let the computer promptly quit the suspension status to resume its original status before suspension status.

### BACKGROUND OF THE INVENTION

1. Field of the Invention

This invention generally relates to a computer system having a universal serial bus (USB) and, more particularly, to a wake-up system and method for universal serial bus of computer wireless input device.

2. Description of the Related Art

Conventional computer system generally comprises a computer main body managing information and various peripheral devices processing the information. FIG. 1 shows a configuration of this computer system including a computer main body 1, a keyboard 2, a mouse 3 and a monitor 4, wherein the keyboard 2 and mouse 3 are input means for inputting information and commands into computer main body 1, and the monitor 4 is an output means displaying information transmitted from the computer on its display picture as an image. In addition, a modem, printer, sound device and scanner are used as computer peripheral devices. Each of these devices must occupy an input/output port on the motherboard in the computer. For this, a user is required to open the computers cases and insert interface cards for the slots into the motherboard. However, since there are limits in the number of slots of the computer, the addition of peripheral devices is not possible when the slots are all occupied.

To meet the demand for more various convenient peripheral devices and to overcome the above-mentioned problem for conventional computer, a computer using a universal serial bus (USB), such as U.S. Pat. No. 6,009,529, has been developed. As shown in FIG. 2, a USB 10 is connected to a computer main body 1, and the keyboard 2, mouse 3, monitor 4, printer 5, scanner 6 and modem 7 are respectively connected to the USB 10. With the use of this USB, the addition of peripheral devices becomes very easy, so that there is no need for the user to open the computer case to connect peripheral devices or related cards. The USB 10 has extension hubs providing additional connection sockets and can be connected in tree shape. The USB can connect 127 other devices in total to one computer. Furthermore, the USB has rapid data transmission rate of 12 Mbite/sec so that it can provide vast processing capacity for most peripheral devices having higher band widths. Accordingly, the USB has two main effects of simplicity and convenience, and will become the main feature for the next generation computer.

Referring to FIG. 3, a USB 10 is connected to computer main body 1, and the monitor 4, printer 5, scanner 6, modem 7 and a receiver 8 are respectively connected to the USB 10. The wireless keyboard 2 and wireless mouse 3 transmit infrared or RF signals to be received by the receiver 8. When the computer is provided with a power management function, the power management will reduce the power consumption for any device in the computer or the whole computer system. When the computer is at suspension status, the power management will close the power for the monitor and hard disk so as to reduce the power consumption thereof. When the user wants to use the computer again, the computer will quit the suspension status promptly and resume its original status before suspension status.

However, when the computer is at suspension status, both the USB 10 and the devices connected thereto are also at suspension status. According to the USB specification, the operating current (Iₒₚ) must be less than 500 mA for operating mode and the average current (Iₐᵥₑ) must be less than 2.5 mA for suspension mode. For the receiver 8, the operating current (Iₒₚ) is 80 mA for operating mode and the suspension current (Iₛᵤₛ) is 50 μA for suspension mode. Since the average current (Iₐᵥₑ) of USB 10 is less than the operating current (Iₒₚ) of the receiver 8 during suspension mode, the USB 10 fails to provide sufficient current for the receiver 8 to resume its operating mode. When the user wants to use the computer again by operating the wireless keyboard 2 or mouse 3, the receiver 8 connected to the USB 10 is unable to resume its operating mode to receive the remote wake-up signal from the wireless keyboard 2 or mouse 3 to let the computer promptly quit the suspension status to resume its original status before suspension status.

In views of this problem, there is provided a switch at the receiver 8. When the user wants to use the computer again, the user has to actuate the switch to let computer quit the suspension status and resume its original status before suspension status. However, such a manner is not only very inconvenient for the user but also destroys the function of wireless input devices.

### SUMMARY OF THE INVENTION

It is an object of the present invention to provide a wake-up system and method for universal serial bus of computer wireless input device such that the wireless input device is able to wake up the USB to let the computer promptly quit its suspension status to resume its original status before suspension status.

According to the preferred embodiment of the present invention, the computer system mainly comprises a USB connected to computer main body, and a monitor, a printer, a scanner, a modem and a receiver are respectively connected to the USB, wherein the wireless keyboard and wireless mouse transmit infrared or RF signals to be received and detected by the receiver. The operating current (Iₒₚ) of the receiver is 80 mA for operating mode and the suspension current (Iₛᵤₛ) thereof is 50 μA for suspension mode.

According to the present invention, when the power management function of the computer system switches the computer and the USB into suspension mode, the receiver is set to switch between a suspension mode of T1 period and an operating mode of T2 period, and the average current (Iₐᵥₑ) of the receiver must be less than the limit average current (SUBIₐᵥₑ) of USB during the suspension mode. According to the preferred embodiment of the present invention, during the suspension mode, the suspension mode of T1 period is set as 485 ms and the operating mode of T2 period is set as 15 ms. As noted above, the receiver has the operating current (Iₒₚ) of 80 mA for operating mode and the suspension current (Iₛᵤₛ) of 50 μA for suspension mode. Accordingly, the receiver of the present invention has an average current (Iₐᵥₑ) of 2.449 mA.

For ensuring the wake-up signals from the wireless input devices to be received and detected by the receiver during its operating mode of T2 period, the wireless input devices of the present invention have to transmit a continuous wake-up signal with a duration longer than the switch period (T1+T2) of the receiver. Therefore, when the computer is at suspension status and the user wants to use the computer again, the user can operate the wireless keyboard or mouse to transmit a continuous wake-up signal which can be received and detected by the receiver during its operating mode (15 ms for example) to let the computer promptly quit the suspension status to resume its original status before suspension status.

### BRIEF DESCRIPTION OF THE DRAWINGS

Other objects, aspects and advantages will become apparent from the following description of the embodiment with reference to the accompanying drawings in which:

FIG. 1 is a diagram showing a configuration of a conventional computer system;

FIG. 2 is a diagram showing a configuration of a conventional computer system with USB;

FIG. 3 is a diagram showing a configuration of a computer system with USB in accordance with the present invention, wherein the keyboard and mouse are wireless input devices;

FIG. 4a is diagram showing the suspension mode and the operating mode of the receiver in accordance with the present invention; and

FIG. 4b is diagram showing the wake-up signal of the wireless input device in accordance with the present invention.

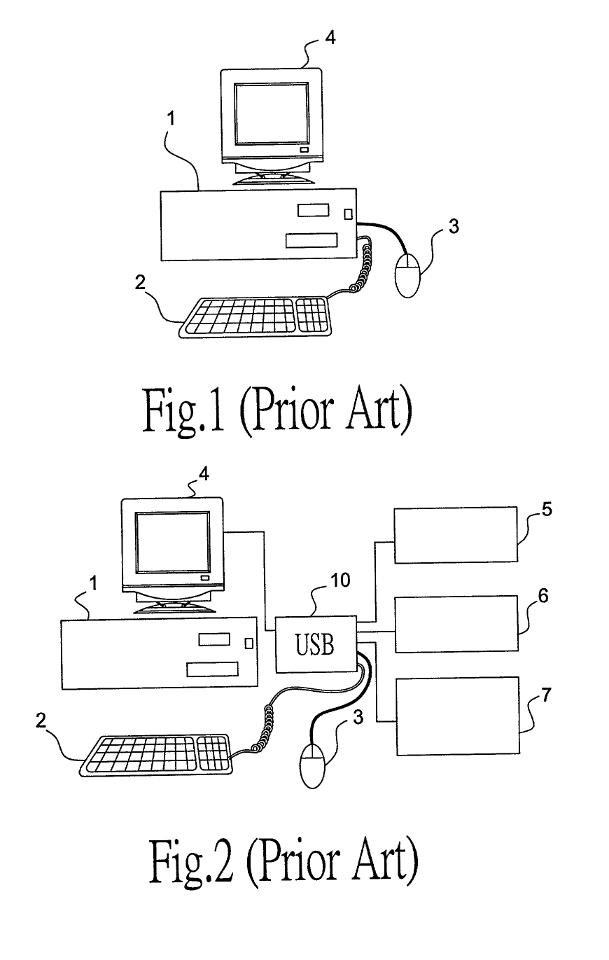

### DETAILED DESCRIPTION OF THE PREFERRED EMBODIMENT

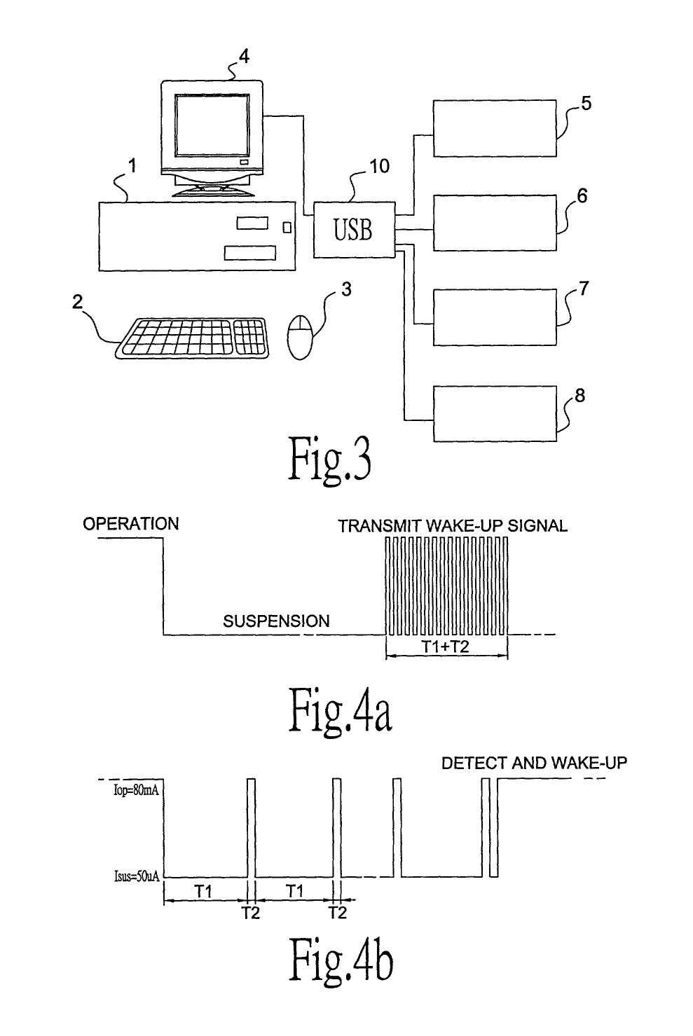

Referring to FIG. 3, the computer system of the present invention mainly comprises a USB 10 connected to computer main body 1, wherein the monitor 4, printer 5, scanner 6, modem 7 and a receiver 8 are respectively connected to the USB 10, the wireless keyboard 2 and wireless mouse 3 transmit infrared or radio frequency (RF) signals to be received by the receiver 8 to control and operate the program executed by the computer main body 1. When the user does not use the computer for a predetermined period, the power management will switch the computer system from an operating mode into a suspension mode so as to reduce the power consumption for any device in the computer or the whole computer system.

According to the specification of current USB 10, all devices of the USB are defaulted as low power. In the low power operating mode, all low power device and high power device are limited to the maximum suspension current of 500 μA. When a device is defaulted as high power and can be remotely waken up, such a device can consume a maximum average current of 2.5 mA in suspension mode. In suspension mode, the current consumed by a device might greater than the average current, but the maximum amplitude of the current peak must be less than the current rating of the device and the average period must be less than 1 second. According to the USB specification, the operating current (Iₒₚ) must be less than 500 mA for operating mode and the average current (Iₐᵥₑ) must be less than 2.5 mA for suspension mode. Generally, for the receiver 8, the operating current (Iₒₚ) is 80 mA for operating mode and the suspension current (Iₛᵤₛ) is 50 μA for suspension mode.

Referring to FIG. 4a, according to the present invention, when the power management function of the computer system switches the computer and the USB 10 into suspension mode, the receiver 8 is set to switch between a suspension mode and an operating mode, and the average current (Iₐᵥₑ) of the receiver 8 must be less than the limit average current (SUBIₐᵥₑ) of USB 10 during suspension mode. That is, the average current (Iₐᵥₑ) of the receiver 8 is less than 2.5 mA during the suspension mode of the computer system. According to the present invention, the receiver 8 is set to switch between a suspension mode of T1 period and an operating mode of T2 period, and the average current (Iₐᵥₑ) of the receiver must be less than the limit average current (SUBIₐᵥₑ) of USB during suspension mode. That is, (Iₛᵤₛ)*(T1/T1+T2)+(Iₒₚ)*(T2/T1+T2)<(SUBIₐᵥₑ).

According to the preferred embodiment of the present invention, for the receiver 8 during suspension mode, the suspension mode of T1 period is set as 485 ms and the operating mode of T2 period is set as 15 ms. As noted above, the receiver has the operating current (Iₒₚ) of 80 mA for operating mode and the suspension current (Iₛᵤₛ) of 50 μA for suspension mode. Accordingly, the receiver 8 of the present invention has an average current (Iₐᵥₑ) of 2.449 mA.

Therefore, during suspension mode, the receiver 8 of the present invention has an average current (Iₐᵥₑ) of 2.449 mA, which is less than the limit average current (SUBIₐᵥₑ) of 2.5 mA for the USB 10. During suspension mode of the computer system, the receiver 8 of the present invention is set to switch between a suspension mode and an operating mode, wherein the average current (Iₐᵥₑ) of the receiver 8 is less than the limit average current (SUBIₐᵥₑ) of USB 10 during suspension mode such that the receiver 8 is able to receive and detect the infrared or RF signals from the wireless keyboard 2 or the wireless mouse 3 to let the computer promptly quit the suspension status to resume its original status before suspension status.

Referring to FIG. 4b, for ensuring the wake-up signals from the wireless input devices, the wireless keyboard 2 or the wireless mouse 3, to be received and detected by the receiver 8 during its operating mode of T2 period, 15 ms for example, the wireless input devices of the present invention have to transmit a continuous wake-up signal with a duration longer than the switch period (T1+T2), 500 ms for example, of the receiver 8. Preferably, the wireless input devices of the present invention have a continuous wake-up signal with a duration twice as the switch period (T1+T2), 1 second for example, to ensure the receiver 8 to detect and receive the wake-up signal two times. Accordingly, when the computer is at suspension status and the user wants to use the computer again, the user can operate the wireless keyboard 2 or mouse 3 to transmit a continuous wake-up signal which can be received and detected by the receiver 8 during its operating mode (15 ms) to let the computer promptly quit the suspension status to resume its original status before suspension status.

Although the invention has been explained in relation to its preferred embodiment, it is to be understood that many other possible modifications and variations can be made without departing from the spirit and scope of the invention as hereinafter claimed.

What is claimed is:

1. A wake-up system for universal serial bus of computer wireless input device comprising:
a computer main body having a power management device and at least one wireless input device outputting operating signals, the power management device switching the computer main body between an operating mode and a suspension mode;
a universal serial bus (USB) connected to the computer main body, the USB having a limit average current (SUBIₐᵥₑ) during the suspension mode;
a receiver connected to the USB for receiving the operating signals output from the wireless input device, wherein the receiver has an operating current (Iₒₚ) for the operating mode and a suspension current (Iₛᵤₛ) for the suspension mode, the receiver is set to switch between a suspension mode of T1 period and an operating mode of T2 period, and (Iₛᵤₛ)*(T1/T1+T2)+(Iₒₚ)*(T2/T1+T2)<(SUBIₐᵥₑ);
whereby when the computer is at the suspension status and the user wants to use the computer again, the user can operate the wireless input device to transmit a continuous wake-up signal with a duration no less than (T1+T2) to let the computer promptly quit the suspension status to resume its original status before suspension status.

2. The wake-up system for universal serial bus of computer wireless input device as claimed in claim 1, wherein the limit average current (SUBIₐᵥₑ) is less than 2.5 mA, the receiver has the operating current (Iₒₚ) of 80 mA for operating mode and the suspension current (I_{SUS}) of 50 μA for suspension mode.

3. The wake-up system for universal serial bus of computer wireless input device as claimed in claim 2, wherein the suspension mode of T1 period is 485 ms and the operating mode of T2 period is 15 ms.

4. The wake-up system for universal serial bus of computer wireless input device as claimed in claim 3, wherein the wireless input device outputs a continuous wake-up signal with a duration twice as the switch period (T1+T2).

5. A wake-up method for universal serial bus of computer wireless input device comprising the steps of:
providing a computer main body having a power management device and at least one wireless input device outputting operating signals, the power management device switching the computer main body between an operating mode and a suspension mode;
connecting a universal serial bus (USB) to the computer main body, the USB having a limit average current (SUBIₐᵥₑ) during the suspension mode;
connecting a receiver to the USB for receiving the operating signals output from the wireless input device, wherein the receiver has an operating current (Iₒₚ) for the operating mode and a suspension current (Iₛᵤₛ) for the suspension mode, the receiver is set to switch between a suspension mode of T1 period and an operating mode of T2 period, and (Iₛᵤₛ)*(T1/T1+T2)+(Iₒₚ)*(T2/T1+T2)<(SUBIₐᵥₑ);
when the computer is at the suspension status and the user wants to use the computer again, the user can operate the wireless input device to transmit a continuous wake-up signal with a duration no less than (T1+T2) to let the computer promptly quit the suspension status to resume its original status before suspension status.

6. The wake-up method for universal serial bus of computer wireless input device as claimed in claim 5, wherein the limit average current (SUBIₐᵥₑ) is less than 2.5 mA, the receiver has the operating current (Iₒₚ) of 80 mA for operating mode and the suspension current (I_{SUS}) of 50 μA for suspension mode.

7. The wake-up method for universal serial bus of computer wireless input device as claimed in claim 6, wherein the suspension mode of T1 period is 485 ms and the operating mode of T2 period is 15 ms.

8. The wake-up method for universal serial bus of computer wireless input device as claimed in claim 7, wherein the wireless input device outputs a continuous wake-up signal with a duration twice as the switch period (T1+T2).
